(19) United States
(12) Patent Application Publication
(10) Pub. No.: US 2016/0089616 A1
(43) Pub. Date: Mar. 31, 2016

(54) MOISTURE- HARVESTING DEVICE

(71) Applicant: ALL ROUND CORPORATION, Tokyo (JP)

(72) Inventor: Eiichi MARUYAMA, Tokyo (JP)

(73) Assignee: ALL ROUND CORPORATION, Tokyo (JP)

(21) Appl. No.: 14/891,474

(22) PCT Filed: May 13, 2014
(86) PCT No.: PCT/JP2014/062697

§ 371 Date: Nov. 16, 2015

(30) Foreign Application Priority Data
May 16, 2013 (JP) 2013-104175

(51) Int. Cl. B01D 5/00; B01D 46/00; C02F 1/32; B01D 29/56; C02F 1/44

(52) U.S. Cl. CPC B01D 5/0033; B01D 29/56; C02F 1/441; C02F 1/32; B01D 46/0028; C02F 2303/04

(57) ABSTRACT

A moisture-harvesting device capable of harvesting moisture, which can be also used as drinking water or the like, from atmospheric air. The moisture-harvesting device includes: an atmospheric-air introduction unit; an atmospheric moisture converter that is provided with a mechanism for reducing a pressure of atmospheric air introduced by the atmospheric-air introduction unit and is equipped with a cooling section for cooling the introduced atmospheric air and extracting a moisture content; a water intake cock, that extracts water obtained by the atmospheric moisture converter; and a filter unit that has first to fifth fitters and is provided at an upstream side from the water intake cock, and removes foreign matter from the water obtained by the atmospheric moisture converter, whereby it is possible to harvest the moisture, which can be also used as the drinking water or the like, from the atmospheric air.

### TECHNICAL FIELD

The present invention relates to a moisture-harvesting device, and more particularly, to a moisture-harvesting device for collecting moisture content contained in atmospheric air.

### BACKGROUND ART

Examples of these kinds of the moisture-harvesting devices are disclosed in Patent Literatures 1 and 2 which are known.

The moisture-harvesting device disclosed in Patent Literature 1 includes an atmospheric-air suction unit, an atmospheric moisture converter that is provided with a mechanism for reducing a pressure of the atmospheric air introduced by the atmospheric-air suction unit and is equipped with a cooling section for cooling the introduced atmospheric air to extract moisture content, and a water intake port for extracting water obtained by the atmospheric moisture converter.

According to the moisture-harvesting device, a large amount of atmospheric air is introduced into the device by driving of the atmospheric-air suction unit, the amount of water is condensed by the atmospheric moisture converter depending on the moisture content contained in the atmospheric air at that time, and thus the water can be extracted from the water intake port.

The moisture-harvesting device disclosed in Patent Literature 2 includes an atmospheric-air introduction unit, a warming unit capable of raising a temperature of the introduced atmospheric air, an atmospheric moisture converter that is provided with a mechanism for reducing a pressure of the atmospheric air introduced by the atmospheric-air introduction unit and is equipped with a cooling section for cooling the introduced atmospheric air to extract moisture content, and a water intake port for extracting water obtained by the atmospheric moisture converter.

According to the moisture-harvesting device, even when the temperature of the atmospheric air is low as in winter, the moisture content contained in the atmospheric air can be increased and the temperature of the introduced atmospheric air can be raised by the warming unit, whereby it is not necessary to reduce the pressure of the atmospheric air. Therefore, it is possible to increase the amount of atmospheric air to be introduced and to extract water from the moisture content present in the large amount of atmospheric air. Accordingly, there are advantages of having moisture-harvesting efficiency larger than that of the moisture-harvesting device disclosed in Patent Literature 1 and of harvesting moisture content from the atmospheric air even when the foundation is low as in winter.

### CITATION LIST

### Patent Literatures

### Patent Literature 1: JP 4-250231 A

### Patent Literature 2: JP 4593698 B2

### SUMMARY OF INVENTION

### Technical Problem

Incidentally, atmospheric air contains dust such as fine dirt. In the moisture-harvesting device disclosed in Patent Literature 1, the atmospheric pressure reducing mechanism is configured by a porous ventilation body provided in an atmospheric-air introduction port, and the dust can be removed by the porous ventilation body.

However, even in the case of removing the dust in this way, if dust is subsequently mixed by any reason, it is not preferred when water mixed with the dust is especially used as drinking water.

Furthermore, in the moisture-harvesting device disclosed in Patent Literature 2, the atmospheric pressure reducing mechanism is configured by a porous ventilation body provided in an atmospheric-air introduction port, and the dust can be removed by the porous ventilation body. Simultaneously, a filter is formed at an upstream side of the porous ventilation body, and the dust contained in the atmospheric air can be also removed by the filter.

However, removing the dust in this way is not preferred when dust is subsequently mixed by any reason, especially when water mixed with the dust is used as drinking water.

The present invention has been made in view of the above circumstances, and an object thereof is to provide a moisture-harvesting device capable of easily harvesting moisture, which can be also used as drinking water or the like, from atmospheric air.

### Solution to Problem

To achieve the above object, a moisture-harvesting device of the present invention includes: an atmospheric-air introduction unit; an atmospheric moisture converter that is provided with a mechanism for reducing a pressure of atmospheric air introduced by the atmospheric-air introduction unit and is equipped with a cooling section for cooling the introduced atmospheric air and extracting a moisture content; a water intake port that extracts water obtained by the atmospheric moisture converter; and a filter unit that is provided at an upstream side from the water intake port and removes foreign matter from the water obtained by the atmospheric moisture converter.

In the present invention, even when the foreign matters such as dust are mixed in the moisture obtained by the atmospheric moisture converter, after the foreign matters are removed from the moisture by the filter unit, the water can be taken from the water intake port. Thus, it is possible to easily harvest the moisture, which can be also used as the drinking water or the like, from the atmospheric air.

In the above configuration of the present invention, the filter unit preferably include a first filter that removes solid sediment contained in the water, a second filter that removes bacteria, organic chemicals, and compounds contained in the water, a third filter that removes an unusual odor in the water, a fourth filter that has a reverse osmotic membrane, and a fifth filter that is formed with ceramic.

It is preferable that these five kinds of filters be sequentially arranged in the order of the first to fifth filters from the upstream side, but the order of the filters may be appropriately changed. However, the fifth filter is arranged at the most downstream side.

According to this configuration, the solid sediment contained in the water obtained by the atmospheric moisture converter is removed by the first filter, the bacteria, organic chemicals, and compounds contained in the water are removed by the second filter, the unusual odor in the water is removed by the third filter, and the virus is removed by the fourth filter. In this manner, after most of the foreign matters mixed in the water are removed by the first to fourth filters, the water is activated and the mineral content or the pH of the water is adjusted by the fifth filter, so that the body-friendly water can be obtained. The obtained water is further preferred as drinking water.

Here, the first filter can preferably remove solid sediment having a size of 5 μm or larger in the water, and a PP filter made of, for example, a polypropylene (PP) fiber is preferably used.

An example of the second filter may include an activated charcoal filter made of activated charcoal which can remove bacteria, organic chemicals, or compounds contained in the water.

An example of the third filter may include a CTO filter capable of removing chlorine, taste, or odor.

Since the fourth filter has a reverse osmotic membrane, it can remove viruses or the like.

An example of the fifth filter may include a ceramic filter which is made of ceramic and has a function of stabilizing pH by addition of at least calcium.

In the ceramic filter, for example, six kinds of ceramics are used.

A first ceramic can activate water. The water creates a molecule group (cluster) by a hydrogen bond between water molecules and forms a community such as a bunch of grapes. In general, it is said that the cluster of clean water is small but the cluster of dirty water becomes enlarged. In order to make the cluster of the water small and to activate the water, for example, the water is brought into contact with the ceramic material. In this way, when the contact between the water and a far infrared ray emitted from the ceramic is effectively increased, continuous water molecules are split and thus a small cluster can be obtained. Thus, the water is activated, so that it is possible to obtain vital water which can be comfortably absorbed in a body.

A second ceramic is formed with an antibacterial ceramic capable of suppressing multiplication of various bacteria and can make safety water.

A third ceramic is formed with an oxide ceramic which hardly destroys a valuable nutrient such as vitamin C.

A fourth ceramic is formed with a natural ceramic and adjusts various natural minerals to make body-friendly water.

A fifth ceramic is formed with a calcium phosphate ceramic and adds calcium and various minerals to stabilize the pH.

A sixth ceramic is formed with a ceramic which stabilizes the pH to a weak alkaline.

Further, in the above configuration of the present invention, the moisture-harvesting device preferably includes: a water storage tank that stores the water obtained by the atmospheric moisture converter and is provided at an upstream side of the filter unit; and a UV sterilization lamp that performs UV sterilization on the water stored in the water storage tank.

According to this configuration, when the water is stored in the water storage tank, since the multiplication of the bacteria in the water storage tank can be prevented by the UV sterilization of the UV sterilization lamp, it is possible to store the water with confidence. Then, after the foreign matters of the stored water are removed by the filter unit as described above, the water can be taken from the water intake port.

Further, in the above configuration of the present invention, an air filter capable of remove foreign matter such as bacteria, virus, and dust from the atmospheric air introduced by the atmospheric-air introduction unit is preferably provided at an upstream side from the atmospheric-air introduction unit.

Here, as the air filter, for example, a board (a “Bio sol board” manufactured by Sicknon Corporation) formed by integration of charcoal or bamboo charcoal and chaff charcoal can be used. Particles of nano-micron size called a “bio sol” exist in the “Bio sol board”, and the particles can catch and inactivate (inhibit virus multiplication and thus neutralize infectivity) the bacteria or viruses as well as the dust such as dirt.

Furthermore, the Bio sol board sustains the effect only by washing. For example, after the Bio sol board is put in hot water of about 60° C. and is washed for about 30 minutes, the effect of the Bio sol board is recovered only by drying in an airy place away from direct sunlight.

According to this configuration, since the air filter capable of removing the foreign matter such as bacteria, virus, and dust from the atmospheric air is provided at the upstream side from the atmospheric-air introduction unit, the foreign matter such as the bacteria, the virus, and the dust is removed from the atmospheric air introduced by the atmospheric-air introduction unit and then the moisture can be harvested from the atmospheric air.

Further, in the above configuration of the present invention, the moisture-harvesting device desirably includes: a warming unit that is capable of raising a temperature of the atmospheric air introduced by the atmospheric-air introduction unit to be in a temperature range of from 20° C. to 50° C.

According to this configuration, even when the temperature of the atmospheric air is low as in winter, the moisture content contained in the atmospheric air can be increased and the temperature of the introduced atmospheric air can be raised by the warming unit, whereby it is not necessary to reduce the pressure of the atmospheric air. Therefore, it is possible to increase the amount of atmospheric air to be introduced and to extract the water from the moisture content present in the large amount of atmospheric air. Accordingly, it is possible to efficiently harvest the moisture content from the atmospheric air even when the temperature is low as in the winter.

### Advantageous Effects of Invention

According to the present invention, even when the foreign matters are mixed in the moisture obtained by the atmospheric moisture converter, after the foreign matters are removed from the moisture by the filter unit, the water can be taken from the water intake port. Thus, it is possible to easily harvest the moisture, which can be also used as the drinking water or the like, from the atmospheric air.

### BRIEF DESCRIPTION OF DRAWINGS

FIG. 1 is a diagram illustrating of a schematic configuration of a moisture-harvesting device according to the present embodiment.

FIG. 2 is a cross-sectional view illustrating a schematic configuration of the moisture-harvesting device according to the present embodiment.

FIGS. 3(a) to 3(c) illustrate an arrangement state of internal components of the moisture-harvesting device according to the present embodiment, and are a left side view, a rear view, and a right side view, respectively.

FIG. 4 is a diagram illustrating a schematic configuration of a filter unit and a water storage tank according to the present embodiment.

### DESCRIPTION OF EMBODIMENT

An embodiment of the present invention will be described below with reference to the accompanying drawings.

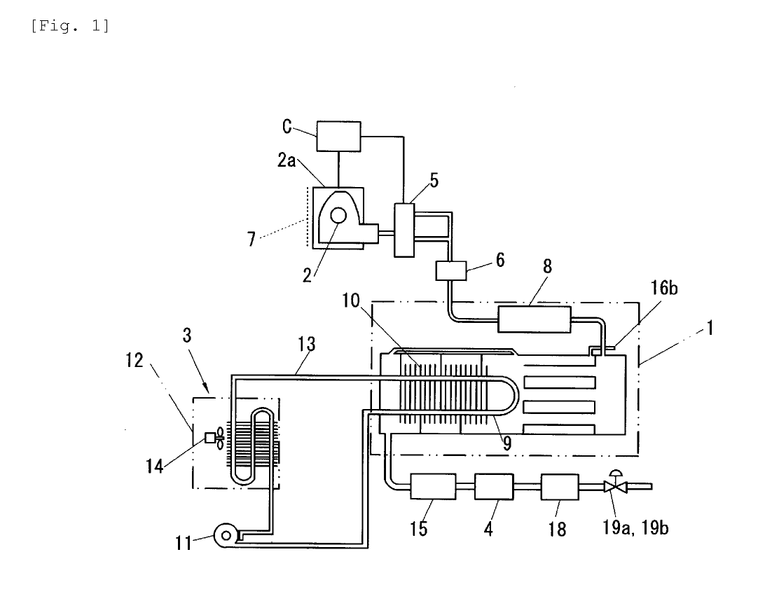

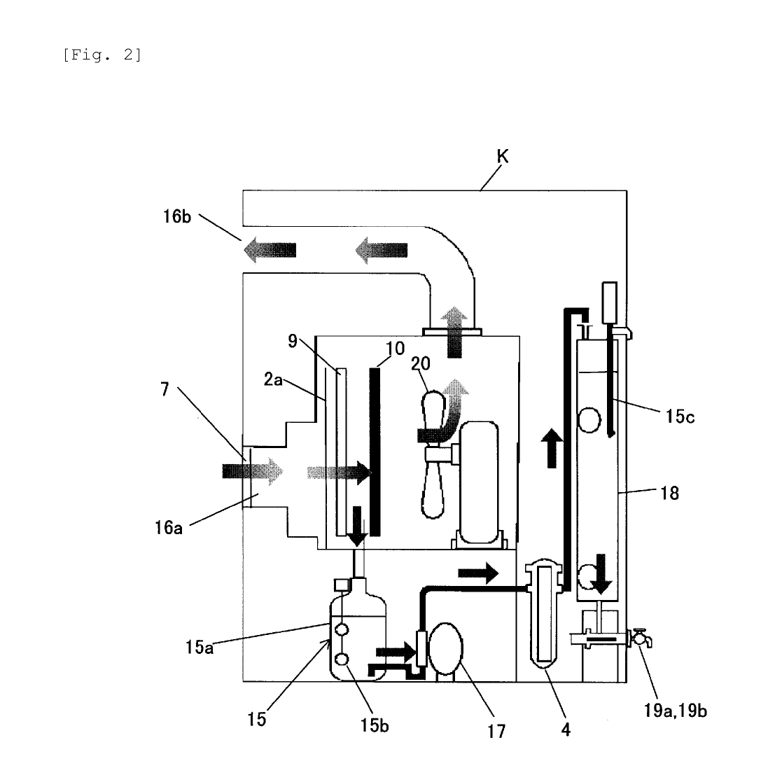

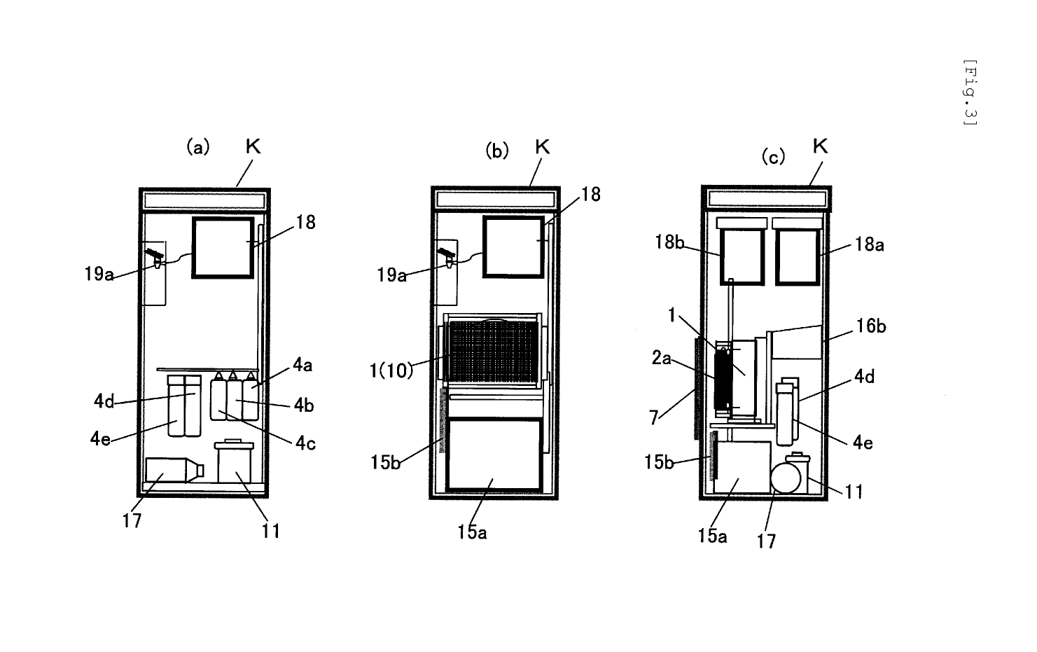

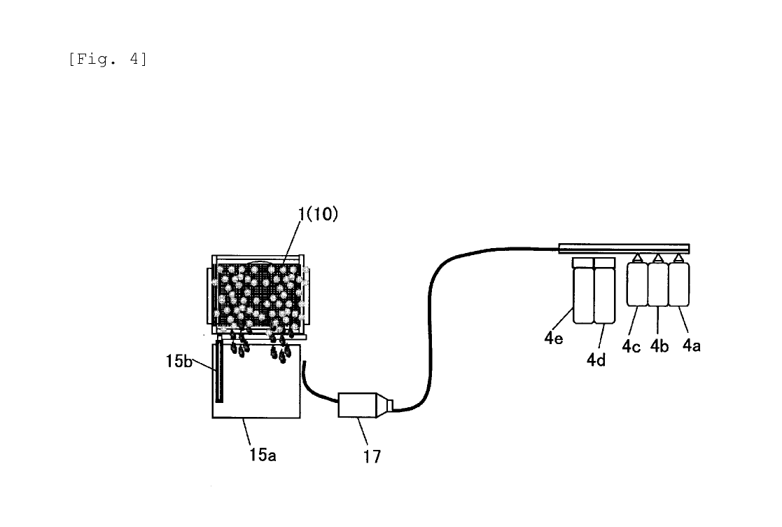

FIG. 1 is a diagram illustrating of a schematic configuration of a moisture-harvesting device configured to obtain drinking water, FIG. 2 is a cross-sectional view illustrating a schematic configuration of the moisture-harvesting device, and FIGS. 3(a) to 3(c) illustrate an arrangement state of internal components of the moisture-harvesting device, and are a left side view, a rear view, and a right side view, respectively. FIG. 4 is a diagram illustrating a schematic configuration of a filter unit and a water storage tank.

As illustrated in FIG. 1, the moisture-harvesting device includes an atmospheric moisture converter 1 that is configured to take out a moisture content contained in the introduced atmospheric air, a suction pump 2 that is an atmospheric-air introduction unit configured to introduce a large amount of atmospheric air into the atmospheric moisture converter 1, a cooling mechanism 3 that is configured to deliver a refrigerant used to cool the atmospheric air introduced into the atmospheric moisture converter 1, and a filter unit 4 that is configured to remove foreign matters from moisture obtained by the atmospheric moisture converter 1.

The suction pump 2 is provided with a warming unit 2a for temperature rising of the atmospheric air to be introduced into the atmospheric moisture converter 1. The warming unit 2a is equipped with a heater made of a heating wire or the like and thus is controlled such that the atmospheric air becomes a certain temperature or higher, while monitoring a warming state of the atmospheric air with a temperature sensor (not illustrated). In this case, a temperature control is performed by a control unit C. The warming allows the atmospheric air to be heated to 20 to 50° C. and preferably to 40 to 50° C., for example, when the temperature of the atmospheric air is near 0° C. at a cold period such as winter, so that a saturated moisture content (amount of saturated water vapor) in the atmospheric air can be increased and the moisture can be efficiently harvested from the atmospheric air regardless of the season. Accordingly, even in a cold region, it is possible to efficiently use the moisture-harvesting device according to the present embodiment by providing the warming unit 2a. Moreover, since the introduced atmospheric air is in a warming state, moisture-harvesting efficiency is very high compared to the conventional moisture-harvesting device. The configuration of the warming unit 2a may be similar to that of an infrared radiation heater.

In addition, the warming unit 2a is provided in the suction pump 2, but the warming unit 2a is preferably arranged in front of the atmospheric moisture converter 1 when the atmospheric-air introduction unit 2 is constituted by a fan 20 and the fan 20 is arranged behind the atmospheric moisture converter 1 as illustrated in FIGS. 2 and 3(c).

In order to mitigate the adverse effect to be caused when a large amount of atmospheric air sucked by the suction pump 2 are fed at a time, as illustrated in FIG. 1, the sucked atmospheric air is fed to an air volume controller 5 which is configured to branch the sucked atmospheric air into 2 to 4 parts, the atmospheric air is branched as a plurality of atmospheric flows and is somewhat rectified in the air volume controller 5, and then the atmospheric air having a smaller variation width is fed to a next filter 6. That is, although not illustrated in the drawings, a damper is mounted on the inside of the air volume controller 5 and can be opened and closed to adjust the air volume, and the opening/closing amount of the damper is controlled by instruction of the control unit C to uniformly feed the air volume of each branch pipe to the next filter 6.

Although not necessarily required, the air volume controller 5 is preferably provided to stably feed a large amount of atmospheric air and to increase the moisture-harvesting efficiency. For example, the number of the atmospheric flows branched by the air volume controller 5 and the size of the branch pipe can be appropriately selected.

In addition, as illustrated in FIGS. 1 to 3(c), an air filter 7 is provided at an upstream side from the atmospheric-air introduction unit (suction pump, fan, or the like) 1 in an introduction port 16a configured to introduce the atmospheric air into a casing K of the moisture-harvesting device.

The air filter 7 can remove foreign matters such as bacteria, viruses, and dust from the atmospheric air which are introduced by the atmospheric-air introduction unit 2.

As the air filter 7, for example, a board (a “Bio sol board” manufactured by Sicknon Corporation) formed by integration of charcoal or bamboo charcoal and chaff charcoal can be used. Particles of nano-micron size called a “bio sol” exist in the “Bio sol board”, and the particles can catch and inactivate (inhibit virus multiplication and thus neutralize infectivity) the bacteria or viruses as well as the dust such as dirt.

Furthermore, the Bio sol board sustains the effect only by washing. For example, after the Bio sol board is put in hot water of about 60° C. and is washed for about 30 minutes, the effect of the Bio sol board is recovered only by drying the Bio sol board in an airy place away from direct sunlight.

As illustrated in FIG. 1, the atmospheric air obtained by removal of the foreign matters such as the dust, the bacteria, and the viruses using the filter 6 and the air filter 7 is fed to a porous ventilation body 8 that is an atmospheric pressure reducing mechanism configured to reduce an atmospheric pressure for the purpose of efficiently taking the moisture content out of the large amount of atmospheric air introduced from the atmospheric-air introduction unit 2 (20). Although the porous ventilation body 8 can be employed in various forms, since the atmospheric air is warmed to become warm air, it is preferable to use a ventilation body (50 to 120 meshes) made of foam polyurethane, foam polypropylene or the like.

The atmospheric moisture converter 1 includes the porous ventilation body 8 and a cooling section 9 that is configured to cool the atmospheric air introduced from the atmospheric-air introduction unit 2 and to extract the moisture content contained in the atmospheric air.

The cooling section 9 is connected to the cooling mechanism 3. The cooling mechanism 3 can intactly use a cooling apparatus which has been used in general. For example, the cooling mechanism 3 includes a compressor 11 that compresses the refrigerant, a condenser 12 having a fan 14, a pressure reducing mechanism (not illustrated), and a heat storage tank (not illustrated) that stores cold heat, and thus the refrigerant having cold heat (various refrigerants such as ammonia, Freon, and water can be used) is delivered to the cooling section 9 of the atmospheric moisture converter 1 through a pipe 13.

The cooling section 9 is provided with a freezer 10 having a large number of fins, and the atmospheric air cooled by the cooling section 9 is condensed by the freezer 10 and is turned into water. In this way, it is possible to effectively condense the large amount of introduced atmospheric air and to obtain the water.

The atmospheric air (air) from which the water is extracted is discharged to the outside from the air discharge port 16b. Since the air discharged from the air discharge port 16b is in a state where the foreign matters such as the dust, the bacteria, and the viruses are removed by the filter 6 and the air filter 7, the moisture-harvesting device can be also used as an air cleaning apparatus.

The water obtained in this manner is further sent to a sterilizer 15 so as to provide for drinking use. As illustrated in FIGS. 2 and 3(c), the sterilizer 15 includes a water storage tank 15a that stores the water and an UV sterilization lamp 15b that performs UV sterilization on the water stored in the water storage tank 15a. The water storage tank 15a is provided at the upstream side of the filter unit 4 and immediately below the freezer 10. Therefore, the water condensed by the freezer 10 falls down and is stored in the water storage tank 15a, and then the stored water is UV-sterilized by the UV sterilization lamp 15b.

The UV-sterilized water is sent to the filter unit 4 by a pump 17 and passes through the filter unit 4.

As illustrated in FIGS. 3(a) and 4, the filter unit 4 includes a first filter 4a, a second filter 4b, a third filter 4c, a fourth filter 4d, and a fifth filter 4e. In the present embodiment, these filters 4a to 4e are sequentially arranged in this order from the upstream side, but the order of the filters 4a to 4e may be appropriately changed. However, the fifth filter 4e is arranged at the most downstream side.

In addition, all of the filters 4a to 4e have a replaceable cartridge form and are easily replaced and repaired.

The first filter 4a is intended to remove solid sediment in water. Specifically, the first filter 4a can preferably remove solid sediment having a size of 5 μm or larger in the water, and a PP filter made of, for example, a polypropylene (PP) fiber is preferably used.

The second filter 4b is intended to remove bacteria, organic chemicals, or compounds in the water, and an activated charcoal filter made of activated charcoal is preferably used.

The third filter 4b is intended to remove an unusual odor in the water, and a CTO filter capable of removing chlorine, taste, or odor is preferably used.

The fourth filter 4d has a reverse osmotic membrane and can remove viruses or the like. A hole of the reverse osmotic membrane has a size of about 2 nanometers. Even in the current smallest picornavirus or parvovirus, since the size of the virus is about 20 nanometers, the fourth filter 4d can remove almost all of pathogenic bacteria and viruses.

The fifth filter 4e is a porous body, and specifically a ceramic filter made of ceramic.

A first ceramic can activate water. The water creates a molecule group (cluster) by a hydrogen bond between water molecules and forms a community such as a bunch of grapes. In general, it is said that the cluster of clean water is small but the cluster of dirty water becomes enlarged. In order to make the cluster of the water small and to activate the water, for example, the water is brought into contact with the ceramic material. In this way, when the contact between the water and a far infrared ray emitted from the ceramic is effectively increased, continuous water molecules are split and thus a small cluster can be obtained. Thus, the water is activated, so that it is possible to obtain vital water which can be comfortably absorbed in a body.

A second ceramic is formed with an antibacterial ceramic capable of suppressing multiplication of various bacteria and can make safety water.

A third ceramic is formed with an oxide ceramic which hardly destroys a valuable nutrient such as vitamin C.

A fourth ceramic is formed with a natural ceramic and adjusts various natural minerals to make body-friendly water.

A fifth ceramic is formed with a calcium phosphate ceramic and adds calcium and various minerals to stabilize the pH.

A sixth ceramic is formed with a ceramic which stabilizes the pH to a weak alkaline.

With respect to the water passing through the filter unit 4, the solid sediment contained in the water is removed by the first filter 4a; the bacteria, the organic chemicals, the compounds or the like contained in the water are removed by the second filter 4b; the unusual odor in the water is removed by the third filter 4c; and the viruses or the like are removed by the fourth filter 4d. In this manner, after most of the foreign matters mixed in the water are removed by the first to fourth filters, the water is activated and the mineral content or the pH of the water is adjusted by the fifth filter 4e, so that the body-friendly water can be obtained. The obtained water is further preferred as drinking water.

Such water is stored in a tank 18 provided at a top of the inside of the moisture-harvesting device as illustrated in FIGS. 3 (a) to 3 (c). The tank 18 includes a hot water tank 18a and a cold water tank 18b. The hot water tank 18a is equipped with an automatic boiling function and can store hot water of about 80° C. to 90° C. The cold water tank 18b is equipped with a cooling function and can store cold water of about 5° C. to 12° C. As illustrated in FIG. 2, the tank 18 may be provided with the UV sterilization lamp 15c.

Water intake cocks 19a and 19b serving as water intake ports are attached to the hot water tank 18a and the cold water tank 18b, respectively, and it is possible to take the hot water and the cold water from the water intake cocks 19a and 19b.

As described above, according to the moisture-harvesting device of the present embodiment, even when the foreign matters are mixed in the moisture obtained by the atmospheric moisture converter 1, after the foreign matters are removed from the moisture by the filter unit 4, the water can be taken from the water intake cocks 19a and 19b. Thus, it is possible to harvest the moisture, which can be also used as the drinking water or the like, from the atmospheric air introduced by the atmospheric-air introduction unit 2.

In addition, since the multiplication of the bacteria in the water storage tank 15a can be prevented by the UV sterilization, it is possible to store the water with confidence. Then, after the foreign matters of the stored water are removed by the filter unit 4 as described above, the water can be taken from the water intake cocks 19a and 19b.

Furthermore, since the air filter 7 is provided at the upstream side from the atmospheric-air introduction unit 2, the foreign matters such as the bacteria, the viruses, and the dust are removed from the atmospheric air and then the moisture can be harvested from the atmospheric air.

In addition, even when the temperature of the atmospheric air is low as in winter, the moisture content contained in the atmospheric air can be increased and the temperature of the introduced atmospheric air can be raised by the warming unit 2a, whereby it is not necessary to reduce the pressure of the atmospheric air. Therefore, it is possible to increase the amount of atmospheric air to be introduced and to extract the water from the moisture content present in the large amount of atmospheric air. Accordingly, it is possible to efficiently harvest the moisture content from the atmospheric air even when the temperature is low as in winter.

In the embodiment described above, for example, various air filters can be used as the porous ventilation body 8 for reducing the atmospheric pressure as long as it can withstand at a certain continuous warming condition. Instead of the porous ventilation body, a number of baffle plates may be arranged at the atmospheric-air introduction passage and an orifice may be configured. Shortly, in order to reduce the pressure of the introduced atmospheric air, a configuration capable of increasing pressure loss may be provided. The porous ventilation body may be formed with a porous sintered material. The atmospheric pressure reducing mechanism may be configured to reduce the atmospheric pressure in such a manner that the introduced atmospheric air passes through an elongated passage such as spiral pipes and is then introduced into a chamber having a large volume.

Moreover, in order to effectively condense a large amount of introduced atmospheric air, a kind of a condensing agent having a catalytic action may be added to easily facilitate dew condensation. Furthermore, in order to minimize as much as possible the moisture content in the atmospheric air, which releases to the outside, after harvesting the moisture by cooling the atmospheric air, the size of the outlet may be diminished to be small such that the atmospheric pressure of the outlet portion increases.

### REFERENCE SIGNS LIST

1: Atmospheric moisture converter
2: Suction pump (atmospheric-air introduction unit)
20: Fan (atmospheric-air introduction unit)
3: Cooling mechanism
4: Filter unit
4a: First filter
4b: Second filter
4c: Third filter
4d: Fourth filter
4e: Fifth filter
7: Air filter
8: Porous ventilation body (mechanism for reducing atmospheric pressure)
9: Cooling section
15a: Water storage tank
15b: UV sterilization lamp
19a, 19b: Water intake cock (water intake port)

1. A moisture-harvesting device comprising:
an atmospheric-air introduction unit;
an atmospheric moisture converter that is provided with a mechanism for reducing a pressure of atmospheric air introduced by the atmospheric-air introduction unit and is equipped with a cooling section for cooling the introduced atmospheric air and extracting a moisture content;
a water intake port that extracts water obtained by the atmospheric moisture converter; and
a filter unit that is provided at an upstream side from the water intake port and removes foreign matter from the water obtained by the atmospheric moisture converter.

2. The moisture-harvesting device according to claim 1, wherein the filter unit includes a first filter that removes solid sediment contained in the water, a second filter that removes bacteria, organic chemicals, and compounds contained in the water, a third filter that removes an unusual odor in the water, a fourth filter that has a reverse osmotic membrane, and a fifth filter that is formed with ceramic.

3. The moisture-harvesting device according to claim 1, further comprising:
a water storage tank that stores the water obtained by the atmospheric moisture converter and is provided at an upstream side of the filter unit; and
a UV sterilization lamp that performs UV sterilization on the water stored in the water storage tank.

4. The moisture-harvesting device according to claim 1, wherein an air filter capable of remove bacteria, virus, and dust from the atmospheric air introduced by the atmospheric-air introduction unit is provided at an upstream side from the atmospheric-air introduction unit.

5. The moisture-harvesting device according to claim 1, further comprising:
a warming unit that is capable of raising a temperature of the atmospheric air introduced by the atmospheric-air introduction unit to be in a temperature range of from 20° C. to 50° C.; and
a control unit that controls warming conditions of the warming unit such that the introduced atmospheric air is in the temperature range of from 20° C. to 50° C.

6. The moisture-harvesting device according to claim 2, further comprising:
a water storage tank that stores the water obtained by the atmospheric moisture converter and is provided at an upstream side of the filter unit; and
a UV sterilization lamp that performs UV sterilization on the water stored in the water storage tank.

7. The moisture-harvesting device according to claim 2, wherein an air filter capable of remove bacteria, virus, and dust from the atmospheric air introduced by the atmospheric-air introduction unit is provided at an upstream side from the atmospheric-air introduction unit.

8. The moisture-harvesting device according to claim 3, wherein an air filter capable of remove bacteria, virus, and dust from the atmospheric air introduced by the atmospheric-air introduction unit is provided at an upstream side from the atmospheric-air introduction unit.

9. The moisture-harvesting device according to claim 6, wherein an air filter capable of remove bacteria, virus, and dust from the atmospheric air introduced by the atmospheric-air introduction unit is provided at an upstream side from the atmospheric-air introduction unit.

10. The moisture-harvesting device according to claim 2, further comprising:
a warming unit that is capable of raising a temperature of the atmospheric air introduced by the atmospheric-air introduction unit to be in a temperature range of from 20° C. to 50° C.; and
a control unit that controls warming conditions of the warming unit such that the introduced atmospheric air is in the temperature range of from 20° C. to 50° C.

11. The moisture-harvesting device according to claim 3, further comprising:
a warming unit that is capable of raising a temperature of the atmospheric air introduced by the atmospheric-air introduction unit to be in a temperature range of from 20° C. to 50° C.; and
a control unit that controls warming conditions of the warming unit such that the introduced atmospheric air is in the temperature range of from 20° C. to 50° C.

12. The moisture-harvesting device according to claim 4, further comprising:
a warming unit that is capable of raising a temperature of the atmospheric air introduced by the atmospheric-air introduction unit to be in a temperature range of from 20° C. to 50° C.; and
a control unit that controls warming conditions of the warming unit such that the introduced atmospheric air is in the temperature range of from 20° C. to 50° C.

13. The moisture-harvesting device according to claim 6, further comprising:
a warming unit that is capable of raising a temperature of the atmospheric air introduced by the atmospheric-air introduction unit to be in a temperature range of from 20° C. to 50° C.; and
a control unit that controls warming conditions of the warming unit such that the introduced atmospheric air is in the temperature range of from 20° C. to 50° C.

14. The moisture-harvesting device according to claim 7, further comprising:
a warming unit that is capable of raising a temperature of the atmospheric air introduced by the atmospheric-air introduction unit to be in a temperature range of from 20° C. to 50° C.; and
a control unit that controls warming conditions of the warming unit such that the introduced atmospheric air is in the temperature range of from 20° C. to 50° C.

15. The moisture-harvesting device according to claim 8, further comprising:
a warming unit that is capable of raising a temperature of the atmospheric air introduced by the atmospheric-air introduction unit to be in a temperature range of from 20° C. to 50° C.; and
a control unit that controls warming conditions of the warming unit such that the introduced atmospheric air is in the temperature range of from 20° C. to 50° C.

16. The moisture-harvesting device according to claim 9, further comprising:
a warming unit that is capable of raising a temperature of the atmospheric air introduced by the atmospheric-air introduction unit to be in a temperature range of from 20° C. to 50° C.; and
a control unit that controls warming conditions of the warming unit such that the introduced atmospheric air is in the temperature range of from 20° C. to 50° C.
